(19) United States
(12) Patent Application Publication
(10) Pub. No.: US 2002/0186954 A1
(43) Pub. Date: Dec. 12, 2002

(54) Fiber optic array assembly and method of making the same

(75) Inventors: David Liu, Amherst, NH (US); Andrew Leung, Randolph, MA (US); Robert A. Rubino JR., Tolland, CT (US); Matthew B. Miller, Glastonbury, CT (US)

Correspondence Address: VOLPE AND KOENIG, P.C., SUITE 400, ONE PENN CENTER, 1617 JOHN F. KENNEDY BOULEVARD, PHILADELPHIA, PA, 19103, US

(73) Assignee: Schott Optovance, Inc., Southbridge, MA

(21) Appl. No.: 10/134,266

(22) Filed: Apr. 29, 2002

Related U.S. Application Data
(60) Provisional application No. 60/287,508, filed on Apr. 30, 2001.

(51) Int. Cl. G02B 6/00; G02B 6/36

(52) U.S. Cl. 385/137; 385/80; 385/83

(57) ABSTRACT

A fiber optic assembly having a carrier preferably formed at least partially of silicon and having a plurality of V-grooves formed thereon, a lid preferably formed at least partially of silicon, and a 1×N array (N being a positive integer) of optical fibers. Each of the optical fibers is located between a lid and a respective V-groove, contacts the lid along a respective first contact line and is in contact with a respective one of the V-grooves along respective second and third contact lines. An adhesive, preferably a sol-gel, is provided along the first, second and third contact lines of each of the optical fibers of the array. Spaces between the lid and carrier not occupied by the array of optical fibers or the sol-gel define a void area, which is preferably filled with a cross-linked filler, such as an epoxy.

### CROSS-REFERENCE TO RELATED APPLICATIONS

This application claims the benefit of U.S. Provisional Application No. 60/287,508, filed Apr. 30, 2001.

### BACKGROUND

This invention pertains to the bonding of optical fibers to planar waveguide devices to form a high stability, high reliability fiber optic pigtail array for the waveguide device.

The bonding of optical fibers to waveguide devices in the “butt-coupled” configuration with organic adhesives, has long been problematic from the perspective of reliability of the adhesive and the size of the required fiber carrier. In such applications, a fiber carrier is often employed to increase the surface area of the bonding contact line for improved bond stability if visco-elastic creep of the organic adhesive is to be avoided. Unfortunately, the size of the fiber carrier also limits the pitch (the spacing between adjacent waveguides) for multi-channel devices.

V-groove carriers have been employed to provide a high precision, small pitch solution for bonding fibers to waveguide devices. However, if differential coefficient of thermal expansion (CTE) effects between the V-groove carrier and the waveguide chip are to be avoided for large fiber carriers (high channel count devices), the fiber carrier must be made of the same material as the waveguide substrate. For substrates of silicon, this requirement does not present a problem because carriers fashioned from silicon support preferential etching along the crystallographic axis to achieve high precision V-shaped grooves. Alternatively, non-crystalline materials, such as silica, will require micro-mechanical machining of the V-shaped grooves or other “gray level” etching techniques which, to date, have not demonstrated the precision achievable with silicon. Further problems arise for electro-optic waveguide devices fabricated of materials such as lithium niobate for which the CTE is dependent upon crystallographic orientation.

In addition, the use of organic adhesives for bonds between the optical fibers and the waveguide and between the optical fibers and the carrier is not ideal because such adhesives have different CTEs than the optical fibers, waveguide, and carrier. Such a differential can result in reliability problems (including pistoning) if the assembly is subject to temperature fluctuations. Most organic adhesives also have relatively low glass transition temperatures (Tg), which can result in visco-elastic creep. Furthermore, organic adhesives are not compatible with the optical power densities present in today's optical networks (ca. 100 megawatts per square centimeter).

### SUMMARY

Briefly, the invention comprises a fiber optic assembly including a carrier having at least one groove formed thereon, a lid and at least one optical fiber. The optical fibers are placed between the lid and a respective one of the grooves. Each fiber is preferably in contact with the lid along a first contact line and is in contact with the respective groove along a second contact line. As used herein and in the appended claims, the term “contact line” is synonymous with the term “contact area”, both referring to an area in which a portion of an optical fiber contacts a portion of the lid or carrier. The assembly also preferably includes an adhesive located along the first contact line to bond the fibers to the lid and along the second contact line to bond the fibers to the respective groove. Preferably, the adhesive has a glass transition temperature (Tg) of at least 300° C., which is significantly higher than the operating temperature of the assembly and is ideally similar to the V-groove material. The spaces between the lid and carrier not occupied by the optical fibers or the sol-gel define a void area, which is preferably filled with a cross-linked filler.

In another respect, the present invention comprises a fiber optic assembly having a carrier formed at least partially of silicon and having a plurality of V-grooves formed thereon, a lid formed at least partially of silicon, and a 1×N array (N being a positive integer) of optical fibers. Each of the optical fibers of the array is located between a lid and a respective V-groove and contacts the lid along a respective first contact line and is in contact with a respective one of the V-grooves along respective second and third contact lines. A sol-gel is dispensed along the first, second and third contact lines of each of the optical fibers of the array. The sol-gel, after proper heat treatment, provides a chemical bond between each of the fibers and their respective V-grooves and between each of the optical fibers and the lid. Spaces between the lid and carrier not occupied by the array of optical fibers or the adhesive define a void area, which is preferably filled with an epoxy.

### BRIEF DESCRIPTION OF THE DRAWINGS

The following detailed description of the preferred embodiments of the invention will be better understood when read in conjunction with the appended drawings. For the purpose of illustrating the invention, there is shown in the drawings embodiments which are presently preferred. It is understood, however, that the invention is not limited to the precise arrangements and instrumentalities shown. In the drawings:

FIG. 1 is a perspective view of an optical fiber assembly bonded to a waveguide; and

FIG. 2 is an enlarged front view of the optical fiber assembly shown in FIG. 1.

### DETAILED DESCRIPTION OF THE PREFERRED EMBODIMENT(S)

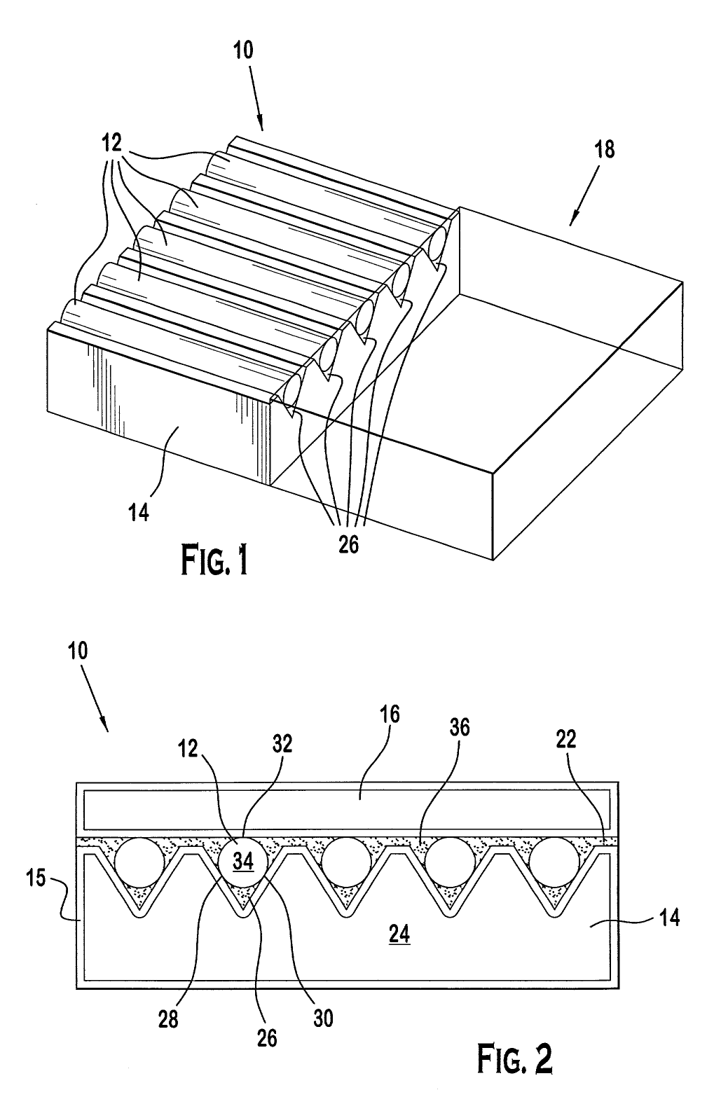

Referring now to FIG. 1, an optical fiber assembly 10 is shown. The assembly 10 comprises a 1×5 array of optical fibers 12, which are sandwiched between a V-groove carrier 14 and a lid 16. Both the V-groove carrier 14 and the lid 16 are preferably formed of glass (silicon dioxide) or silicon coated with a thin layer 15 (e.g., about 1 micron thick) of silicon dioxide. The fiber optic assembly 10 is shown as being “butt-coupled” to a waveguide 18. The array of optical fibers 12 shown in FIGS. 1 and 2 is intended to be merely exemplary. The assembly 10 could be comprised of a single fiber pigtail or any 1×N array of optical fibers 12.

As will be discussed in greater detail below, a sol-gel is used as the primary adhesive for bonding the optical fibers 12 to the V-groove carrier 14 and the lid 16. In general, the sol-gel process involves the transition of a solution system from a liquid colloidal “sol” into a solid “gel” phase. In a typical sol-gel process, the precursor is subjected to a series of hydrolysis and polymerization reactions to form the “sol.” When the “sol” is partially dried, a “wet gel” will form. With further drying and heat treatment, the “gel” is converted into a dense material. With proper activation of the silica of the outer diameter of the optical fibers 12 and special attention during the drying process, chemical bonds are formed between the bonding surfaces, yielding a dense chemical bond.

Referring now to FIG. 2, the formation of the assembly 10 will now be discussed in detail. The grooves 26 are used to accurately position the optical fibers 12 in the finished assembly 10, and therefore, must be formed with precision, using any suitable etching or machining technique. The fibers 12 can be provided as individual fibers or as an array of ribbonized fibers (not shown). First, the optical fibers 12 are placed in a respective one of the grooves 26 of the V-groove carrier 14. The placement of the fibers 12 results in two lines of contact 28 and 30 between each of the optical fibers 12 and its respective groove 26. Any suitable fiber population technology having an accuracy of about 10 micrometers can be used.

Once the optical fibers 12 are in position, the lid 16 is placed atop the optical fibers 12, resulting in a contact line 32 between the lid 16 and each of the optical fibers 12. Preferably, the contact surfaces of the optical fibers 12, V-groove carrier 14 and lid 16 are cleaned with methanol and then activated with a potassium hydroxide solution. The sol-gel solution is then applied to the end face 34 of each of the optical fibers 12. Any suitable sol-gel formulation can be used. For example, a solution of sodium silicate, containing about 14% NaoH and 27% SiO₂ and de-ionized water has been found to work well in this application. In the interest of clarity, only one optical fiber 12, groove 26 and associated contact line labeled in FIG. 2. It should be understood that the features described with respect to the fiber 12 labeled in FIG. 2 apply to all of the fibers 12.

After being applied to the end face 34 of each optical fiber 12, the sol-gel solution spreads over the end face 34 and is drawn down each of the optical fibers 12 along the three contact lines 28, 30, 32 by gravitational and capillary action. A sol-gel solution drop of about 0.1 microliters, applied using an automated syringe has been determined to provide excellent bonding strength, while maintaining positional accuracy of the optical fibers 12.

The sol-gel is then cured using any suitable method including but not limited to, thermal or laser curing. After the sol-gel has cured, the void areas 36 between the lid 16, V-groove carrier 14 and the optical fibers 12 are filled with a cross-linking filler, such as an epoxy 22. The primary purpose for the use of epoxy 22 is to prevent ingress of moisture and/or containments into the void areas 36. Such ingress could cause, among other things, corrosion of the sol-gel chemical bonds under severe environment.

After the epoxy 22 has cured, the face 24 of the fiber optic assembly 10 is preferably polished to provide a clean, smooth contact surface for bonding with the waveguide 18. Due to the above-described advantages of sol-gel as an adhesive, it is also the preferred adhesive for bonding the face 24 of the optical fiber assembly 10 to the waveguide 18.

The preferred embodiment of the present invention provides several advantages over assemblies which use epoxy as the adhesive. Use of a sol-gel solution increases positional accuracy of the optical fibers 12 because a much thinner layer of adhesive (typically less than 200 nm) is required as compared to much greater thickness for the use of epoxy as the adhesive. The sol-gel also has a much higher glass transition temperature (Tg) than epoxies, and therefore, greatly reduces visco-elastic creep in high-temperature applications. In addition, a sol-gel has a CTE that is very similar to that of the optical fibers 12, the V-groove carrier 14 and the lid 16. This reduces pistoning, which is common when epoxy is used as the primary adhesive because the epoxy has a much higher CTE. Since the sol-gel is in effect a glass, intervening sol-gel adhesive between the core of each optical fiber 12 and the corresponding waveguide 18 will introduce minimal loss. Use of a sol-gel as the primary adhesive also provides superior long term stability and durability. Since sol-gel is an inorganic adhesive, problems associated with “out gassing” produced during the curing of organic adhesives are eliminated. Finally, its feature of high chemical stability immunes from undesirable pyrolysis and photolysis effects and this enables high optical power handling capability.

It is recognized by those skilled in the art, that changes may be made to the above-described embodiments of the invention without departing from the broad inventive concept thereof. It is understood, therefore, that this invention is not limited to the particular embodiments disclosed, but is intended to cover all modifications which are within the spirit and scope of the invention.

What is claimed is:

1. A fiber optic assembly comprising:
a carrier having at least one groove formed thereon;
a lid;
at least one optical fiber located between the lid and a respective one of the at least one groove, wherein each of the at least one optical fibers is in contact with the lid along a first contact line and is in contact with the respective groove along a second contact line;
an adhesive located along the first contact line to bond the at least one optical fiber to the lid and along the second contact line to bond the at least one optical fiber to the respective groove and, wherein the adhesive has glass transition temperature of at least about 300° F.; and
wherein spaces between the lid and carrier not occupied by the optical fiber or the adhesive define a void area, the void area being filled with a cross-linked filler.

2. The assembly of claim 1, wherein the adhesive is a sol-gel.

3. The assembly of claim 2, wherein the adhesive is sodium silicate.

4. The assembly of claim 1, wherein the cross-linked filler is an epoxy.

5. The assembly of claim 1, wherein the carrier comprises silicon dioxide.

6. The assembly of claim 1, wherein the carrier comprises silicon coated with a layer of silicon dioxide.

7. The assembly of claim 1, wherein the at least one groove is V-shaped.

8. The assembly of claim 1, wherein the at least one optical fiber is also in contact with the respective groove along a third contact line and the adhesive is located along the third contact line to further bond that at least one optical fiber to the respective groove.

9. The assembly of claim 1, wherein the lid comprises silicon dioxide.

10. The assembly of claim 1, wherein the lid comprises silicon with a silicon dioxide coating.

11. The assembly of claim 1, wherein the at least one optical fiber comprises a 1×N array of optical fibers, N being an integer greater than 1.

12. A fiber optic assembly comprising:
a carrier having at least one groove formed thereon;
a lid;
at least one optical fiber located between the lid and a respective one of the at least one groove, wherein the at least one optical fiber contacts the lid along a first contact line and is in contact with the respective groove along a second contact line; and
a sol-gel located along the first and second contact lines, the sol-gel providing a chemical bond between the at least one optical fiber and the respective groove and between the at least one optical fiber and the lid;
wherein spaces between the lid and carrier not occupied by the at least one optical fiber or the sol-gel define a void area, the void area being filled with an epoxy.

13. The assembly of claim 12, wherein the sol-gel is sodium silicate.

14. The assembly of claim 12, wherein the carrier comprises silicon dioxide.

15. The assembly of claim 12, wherein the carrier comprises silicon coated with a layer of silicon dioxide.

16. The assembly of claim 12, wherein the at least one groove is V-shaped.

17. The assembly of claim 12, wherein the lid comprises silicon dioxide.

18. The assembly of claim 12, wherein the lid comprises silicon with a silicon dioxide coating.

19. The assembly of claim 12, wherein the at least one optical fiber comprises a 1×N array of optical fibers, N being an integer greater than 1.

20. A fiber optic assembly comprising:
a carrier formed at least partially of silicon and having a plurality of V-grooves formed thereon;
a lid formed at least partially of silicon;
a 1×N array of optical fibers, N being a positive integer, wherein each of the optical fibers of the array is located between the lid and a respective V-groove, contacts the lid along a respective first contact line and is in contact with a respective one of the V-grooves along respective second and third contact lines; and
a sol-gel located along the first, second and third contact lines of each of the optical fibers of the array, the sol-gel providing a chemical bond between each of the optical fibers and the respective V-grooves and between each of the optical fibers and the lid;
wherein spaces between the lid and carrier not occupied by the array of optical fibers or the sol-gel define a void area, the void area being filled with an epoxy.
